(19) United States
(12) Patent Application Publication
(10) Pub. No.: US 2013/0330764 A1
(43) Pub. Date: Dec. 12, 2013

(54) Method for Determining the Amount of at Least Some Fatty Acids Contained in Various Biological Materials from a Single Animal Raised for Meat Production

(71) Applicants: Guillaume Chesneau, Luitre (FR); Pierre Weill, Vern Sur Seiche (FR)

(72) Inventors: Guillaume Chesneau, Luitre (FR); Pierre Weill, Vern Sur Seiche (FR)

(73) Assignee: VALOREX, Combourtille (FR)

(21) Appl. No.: 14/001,405

(22) PCT Filed: Feb. 24, 2012
(86) PCT No.: PCT/EP12/53207

§ 371 Date: Aug. 23, 2013

(30) Foreign Application Priority Data
Mar. 3, 2011 (FR) 1151737

(51) Int. Cl. G01N 21/35

(52) U.S. Cl. CPC G01N 21/3563
USPC 435/29

(57) ABSTRACT

The present invention relates to a method for determining, from a database, the amount of at least some fatty acids contained in various biological materials from a single animal raised for meat production. Said method can be used for determining the amount of both major and minor fatty acids, as well as the fatty acid content of another biological material from said single animal.

The invention relates to a method for determining the amount of some fatty acids contained in various biological materials from a single animal raised for meat production.

The fat (or lipid) content of each of the products that we eat is part of the current information appearing on food package labels.

These lipids have been rejected for a long time due to their high calorie and saturated fatty acid content.

For around ten years, scientists have been providing increasing proof that fatty acids should not be rejected. For nutritionists, there are no good or bad fatty acids in the human diet, but only excess or deficient fatty acids inducing numerous physiological imbalances that contribute to the genesis of many so-called “lifestyle” diseases (cardiovascular disease, diabetes, obesity, etc.).

All nutritional guides now recommend:

a. an increase in the consumption of oleic acid (C18:1n-9),

b. an increase in the consumption of omega 3 in the form of alpha linolenic acid (C18:3n-3), EPA (C20:5 n-3) and DHA (C22:6 n-3),

c. a limit in the consumption of palmitic acid (C16:0),

d. a limit in the consumption of linoleic acid (C18:2n-6),

e. a reduction of the C18:2n-6/C18:3n-3 ratio.

There have been many studies in the past ten years seeking to optimize the nutritional composition of the fatty acids in products for human consumption to improve health by following these recommendations. Accordingly, modes of animal production and the composition in fatty acids of their lipids have exceeded the target and methods for determining fatty acid content have been developed.

The diet of the animals plays a major role (greater than genetics and other rearing factors) in determining the fatty acid content of their products.

Therefore, to improve the fatty acid profile of meat, milk or eggs, the raw materials making up the diet must be carefully chosen. In monogastric animals, the lipid profile of the meat is the direct reflection of its diet. In ruminants, this link also exists, but it is blurred by the biohydrogenation function of the rumen, which makes the correlation trickier and dependent on digestive interactions within the rumen.

In addition to the usefulness of knowing the fatty acid composition of products for human consumption for the health thereof, it is also very useful to consider the fatty acid composition of the biological materials making up the animals to characterize the health of these animals.

Indeed, by recognizing certain fatty acids or ratios of fatty acids in known quantities, it is quite possible to make a diagnosis of the nutritional imbalances of diet and, consequently, on metabolic disorders incurred in the medium and long term.

Thus, C18:2 n-6 and C18:3 n-3 fatty acids can only be exogenous (i.e., dietary), because no animal can synthesize them. These vital fatty acids are also called essential because they are important vectors for balancing the endocrine, immune, inflammatory, etc. systems and their oxygenated derivatives are most often antagonists, which leads nutritionists to recommend a C18:2 n-6/C18:3 n-3 ratio to better balance the major metabolic functions of organisms, whether human beings or animals.

This is why it would be useful to inspect in the living animal, by analyzing its blood, skin, fur or any other biological tissue, the balance of this ratio (for example), which is inevitably correlated with the balance of this ratio in the diet which is, in turn, not always known.

This is true for fatty acids of exclusively exogenous origin, but may well also be true for fatty acids of endogenous (or mixed) origin, since their synthesis is modulated by the numerous balances of a diet: calorie intake (in the form of sugar, starch, lipids or complex carbohydrates), protein, fiber mineral, vitamins.

The calorie content of a diet will determine the synthesis and lipolysis of adipose tissue fatty acids, and therefore the fatty acid profile of this tissue will be modified.

Unlike vegetable oils, which contain around twenty major different fatty acids, animal fats, especially of ruminants, are composed of a very large number of different fatty acids.

Nearly 400 different fatty acids are known. The relative proportions of these acids are extremely variable as a function of numerous parameters: breed, individual, season, age and especially diet.

Fatty acids are typically grouped into families illustrated by the following examples of fatty acids:
a. Short chain saturated fatty acids (C4:0, C6:0, C8:0, C10:0);
b. Medium chain saturated fatty acids: lauric acid (C12:0) and myristic acid (C14:0);
c. Long chain saturated fatty acids: palmitic acid (C16:0) and stearic acid (C18:0);
d. Cis or trans monounsaturated acids: oleic acid (C18:1cis9), vaccenic acid (C18:1trans11);
e. Conjugated fatty acids: rumenic acid (C18:2cis9 trans:11);
f. Odd-numbered branched-chain fatty acids;
g. Omega 3 family polyunsaturated fatty acids: alpha linolenic acid (C18:3n-3), eicosapentaenoic acid (C20:5n-3), docosahexaenoic acid (C22:6n-3);
h. Omega 6 family polyunsaturated fatty acids: linoleic acid (C18:2n-6), arachidonic acid (C20:4 n-6).

The large variety and broad dispersion in the fatty acid composition of animal products, on the one hand, and the quantitative importance of animal fat consumption from meat and meat products, on the other hand, makes evaluating the nutritional quality of animal product lipids raised for meat production very important.

Livestock producers are therefore looking to improve the nutritional quality of lipids and meats and meat products. Farms themselves are seeking tools for diagnosing the balance of dietary fats distributed over the animal to optimize the economic profitability of their production by better performance and better health of the animals.

Given this dual enthusiasm for the producer and the consumer, it would be quite useful to be able to evaluate quickly, reliably and affordably, the lipid composition of meat and meat products in dead animals, as well as the biological materials available from live animals (by direct analysis or sampling) to predict the fatty acid profile obtained in meats and meat products. In fact, by the early knowledge of the composition of the blood, skin and fur a few hours, days or months before the animal is slaughtered, for a given diet, it is possible to predict the lipid quality of meats and meat products, in the context of a diet that is stable over time. Thus, for example, if the quantity of omega 3 diagnosed in the meat by fur analysis is insufficient to meet a qualitative objective according to specifications, than advice on changing the animal's diet can be considered to reach the desired goal.

Thus, the present invention relates to a method for determining the amount of at least some of the fatty acids contained in various biological materials of the same animal raised for meat production, from a database in which the fatty acid compositions or profiles have been determined beforehand, for a reference material coming from the same type of animal, determined by gas phase chromatography, then measuring and recording the corresponding infrared absorption spectra or corresponding Raman scattering, a method comprising the following steps:
a/ a calibration equation corresponding to the determination of a fatty acid or a sum of fatty acids by a spectroscopic method is determined for this reference material by a mathematic model;
b/ the use of said calibration equation of the preceding step is validated, in view of its use with new samples to be analyzed, since for a series of so-called “validation” samples of the same nature as the biological reference material, the correlation coefficient r² between the fatty acid content considered or the sum of fatty acids obtained by gas phase chromatography and spectroscopy, is at least equal to 0.7;
c/ a new sample to be analyzed, of the same nature as the reference material, is subjected to light radiation to obtain the absorption spectrum, and the previously validated calibration equation is used to deduce the profile, i.e., the so called “major” fatty acid content, namely those with a correlation coefficient r² at least equal to 0.7,
   characterized by the fact that it also comprises at least one of the following steps:
d/ the profile is determined, i.e., the so-called “minor” fatty acid content, namely those whose coefficient r² is less than 0.7, from the “major” profile as determined in the preceding step, by means of statistical prediction equations with a correlation coefficient r² at least greater than the correlation coefficient r² determined between the values of so called “minor” fatty acids, measured by spectroscopy and the values obtained by gas phase chromatography or by means of statistical prediction equations with a correlation coefficient at least equal to 0.7, obtained with the gas phase chromatography method;
e/ the fatty acid content of at least one other material from the same animal is determined, from the profiles obtained in steps c/ and/or d/, by means of statistical prediction equations having a correlation coefficient at least equal to 0.7, obtained with the gas phase chromatography method.

Preferably, in steps b/, c/, d/ and e/, r² is at least equal to 0.8, preferably at least equal to 0.9.

Furthermore, according to other advantageous and non-limiting characteristics:
said biological material is fluid;
said biological material is blood;
said biological material is solid;
said biological material is chosen from among fur, scales, feathers, skin, fat, meat or offal;
said animal is chosen in the group consisting of cattle, sheep, poultry, pigs, rabbits and fish.

Other advantages and characteristics of the present invention will appear clearly upon reading the description that follows.

### I—MODEL FOR DETERMINING THE FATTY ACID COMPOSITION OF LIPIDS, MEATS AND MEAT PRODUCTS

a. Introduction

The fatty acid profile of product lipids is currently determined by the reference method: gas phase chromatography (GPC). This is used to separate gaseous mixtures as a result of the equilibrium between a mobile gas phase and a stationary phase. Chronologically, the method relies on:

1. a step of extracting the fat,

2. a preparation of fatty acid methyl esters,

3. an analysis by gas-phase chromatography of these fatty acid methyl esters.

However, this method is slow (one to three weeks, depending on the laboratory) and costly (around [symbol] 100 to [symbol] 200 per analysis). It is a considerable obstacle for livestock producers who would like to increase their research and product development or perform quality control on the meat obtained or the balance of a diet.

Accordingly, we considered an equally interesting method in terms of reliability but much faster and less expensive: analysis by infrared or Raman spectroscopy, paired with prediction equations.

The method proposed consists of 3 steps:

The first two steps consist of obtaining a fatty acid profile, quickly, reliably and as complete as possible for a given tissue from the same animal.

The third step allows obtaining a fatty acid profile quickly, reliably and as complete as possible for many tissues from the same animal, and potentially at different times, as long as the diet has not changed.

b. Description of the Method

Step 1:

Partial determination of the lipid composition (from major fatty acids, present in larger quantity)
from one or more lean tissues (meat) or fat (covering fat, intermuscular fat) of an animal raised and then slaughtered for meat production (pigs, cattle, sheep, poultry, fish, etc.)
from one or more tissues (skin, fur, etc.) or biological materials (blood, urine, feces, milk, etc.) of a growing or fattening animal.

by the fast and possibly non-invasive method of infrared or Raman spectroscopy, from measurement equipment available on the market or even ones created for each of the specific applications that it may be necessary to perform (for example, on the slaughter line of pigs, cattle, poultry, etc., or on their epidermis) for increased practicality, robustness, cost, responsiveness, etc.

After making up a large and representative database of samples for which, on the one hand, the composition of the fatty acid profile has been determined by the reference method (GPC) and, on the other hand, light absorption spectra have been obtained from appropriate (but evolving) measurement equipment, an infrared or Raman calibration is obtained for each fatty acid considered by the reference method.

Each calibration is characterized by a degree of reliability.

The more fatty acids or families of fatty acids (e.g., saturated fatty acids) present in large quantity (major fatty acids, for example palmitic acid, oleic acid, stearic acid, etc.) the stronger this reliability.

In return, in order to quickly and reliably obtain fatty acids in small quantity by spectrometry (so-called minor fatty acids, for example alpha linolenic acid, omega 3), in order to obtain a complete fatty acid profile, a second step is necessary.

Step 2:

Determination of minor fatty acids by mathematical prediction equation.

Fatty acids from the same tissue are sometimes very well correlated to each other.

Thus, from major fatty acids obtained by infrared or Raman spectroscopy, it is possible to calculate, by prediction equation (linear or otherwise), the amount of so-called minor fatty acids present in small quantities. Since this second method of evaluation by calculation offers better reliability of results than the first, it is worth using.

Another evaluation of fatty acids insufficiently well predicted directly by infrared or Raman spectroscopy may also be obtained by a mathematical prediction equation in line with constituents other than fatty acids (water, fats, proteins, collagen, salt, etc.) since a close correlation would provide a reliable prediction equation.

Given the number and variability of the tissue composition in the same animal, a third step can be considered to quickly obtain the fatty acid composition of different tissue, possibly at different times if the animal's diet remains stable.

Step 3:

Determination of the fatty acid composition of different tissues of the same animal, or several animals from the same homogenous production lot from knowledge of the fatty acid profile (according to steps 1 and/or 2) of at least one tissue from the same animal or an animal of the same lot.

In fact, by establishing strong correlations of fatty acid composition among different tissues permitting reliable predictions, it becomes possible to know the fatty acid content of a tissue (e.g.: lean muscle by knowing this same fatty acid in another tissue (covering fat).

In the same way, for very homogenous and standardized productions with little variable of the fatty acid composition from one animal to the other (animals raised on the same farm and receiving the same diet up to the same age), it is possible to predict the fatty acid content of one tissue of an animal from the content of this same fatty acid of a tissue of another animal of the same lot.

Finally, it is also possible to anticipate the composition of a tissue (e.g.: meat) in a given fatty acid at a time t (e.g.: slaughter), from knowledge of the composition in another tissue (e.g.: blood) at a time t-h (in hours), t-d (in days) or t-w (in weeks), from the time when the animal receives a stable diet.

Thus, by the use of rapid testing methods for the determination of fatty acid of products, combined with the application of prediction equations among fatty acids (or even from components other than fatty acids but well predicted by spectroscopy and well correlated with the considered fatty acid), or also between parts at a given time (covering fat, intermuscular fat, various muscles) or different times (blood, hair, skin), or among animals of a homogeneous production lot, or finally between the beginning and the end of a cooking process, or other processing, it becomes possible:
to have easy access to important nutritional information like levels of saturated, monounsaturated, polyunsaturated, palmitic (C16:0), oleic (C18:1n-9), linoleic (C18:2 n-6) acids,
alpha-linolenic (C18:3n-3), conjugated linoleic acid (CLA), etc., for each of the food products to consider,
to set up a payment system for products (milk, butter, cheese, meat, ham, deli meats, eggs, etc.) according to their nutritional quality in fatty acids, and therefore to boost the marketing of quality products,
to quickly and efficiently check products from animals raised for meat production and therefore improve creation of specifications with performance obligation and analytical control plan for products among producers, packers, processors and distributors
to accelerate the process of acquiring knowledge by possible increase of the study of factors for quality improvement,
to strengthen the creation of channels for the promotion of products of superior nutritional quality.
to improve the balance of animal diets, animal health and the economic profitability of animal production systems.

### II—PRACTICAL EXAMPLES

Step 1: Partial Determination of the Fatty Acid Profile by Spectroscopy (Infrared Example).

This step seeks to identify the fatty acids predictable in a reliable and robust manner by infrared measurement. This step requires the development of calibration over all the fatty acids measured by GPC. The best calibrations by fatty acids will then be chosen and will define the list of fatty acids reliably predictable by infrared measurement.

This illustration relies on data acquired on pork ribs by a device with the following characteristics:
the spectra acquisition mode used was transmission (infrared spectrum through the sample).
the spectral range used extended from 780 to 2500 nm.

In this illustration, the mathematical models for determining calibrations were developed using “Unscrambler” software.

The methodology described below can be transposed to all tissues and spectroscopic devices to be considered.

a) Acquisition of Infrared Spectra and Reference Analyses (Fatty Acid Profiles)

Spectral measurements were acquired on 70 ground samples of pork ribs, which received diets with different contents of C18:3 n-3.

Simultaneously with these measurements, the fatty acid profiles of these same tissue samples used for acquiring spectral profiles were determined by gas phase chromatography (reference method).

b) Construction of the Data Base.

A database collecting for each sample the values of each point composing its IR spectrum and its fatty acid profile was created, as illustrated below.

Structure of the database permitting statistical research of the relationships between spectral profile obtained by IR and fatty acid profile obtained by GPC.

| | | Wavelength | | | | | Fatty acid profile | | | | |
|---|---|---|---|---|---|---|---|---|---|---|---|
| Sample No. | Diet | 400 | 402 | 404 | . . . | n | C10:0 | C12:0 | C18:3 n-3 | . . . | C24:1 |

| | |
|---|---|
| 1 | A |
| 2 | A |
| 3 | B |
| 4 | B |
| . . . | . . . |
| n | n |

c) Construction of Calibrations

From this database, different statistical methods are used in order to identify the fatty acids that are reliably and accurately predictable from the infrared spectrum.

In this illustration, the collection of spectra is standardized by the MSC (Multiplicative Scatter Correction) method. This transformation limits the dispersion of spectra with regard to one another. Other mathematical pretreatments of the infrared signal may be used. The choice of pre-treatment (first derivative, second derivative, MSC, etc.) may perceptibly impact the calibration quality. Therefore it is necessary to choose the optimal mathematical pretreatment via dedicated software.

For each point of the IR spectrum, a regression coefficient for each fatty acid is calculated by the partial least squares regression method (PLS1).

Each point of the IR spectrum is multiplied by the corresponding regression coefficient. The sum of these products then corresponds to the predicted fatty acid value considered in accordance with the infrared spectrum.

d) Internal Validation

The model is evaluated by the cross validation method.

In this method, the sample data set used for the calibration is divided into n subsets. The calibration is done with n−1 subsets, the last subset serving as the data set for validation. This process is repeated as many times as there are subsets. This method validates the model and tests its predictive ability.

e) Evaluation of the Calibration Quality

The quality of predictions is evaluated from the regression correlation coefficient (R²) and the mean squared prediction error (RMSEP).

Table 1 below summarizes the quality criteria necessary for evaluating the quality of the prediction model. It is therefore possible to reliably define all the fatty acids present in the table below. Only the n-6/n-3 ratios seem, at this stage of the study, potentially difficult to predict. However, a larger database, with a good representation of production modes, may be created to verify these reliability levels.

TABLE 1
Prediction quality criteria obtained on
pork ribs on a limited list of fatty acids and from a
limited database.

| | Nb spectrum | Content | Content | | |
|---|---|---|---|---|---|
| | in the database | Min. | Max. | RMSEP | R² |
| AGS | 138 | 33.7 | 46.7 | 0.63 | 92.13 |
| AGMI | 134 | 40.2 | 49.1 | 0.88 | 83.76 |
| AGPIn-6 | 146 | 6.4 | 15.7 | 0.98 | 80.53 |
| AGPIn-3 | 136 | 1.2 | 4.8 | 0.35 | 81.38 |
| C16:0 | 140 | 20.7 | 27.4 | 0.46 | 83.5 |
| ALA (C18:3n-3) | 133 | 1 | 3.8 | 0.29 | 79.04 |
| LA (C18:2n-6) | 144 | 5.8 | 14.4 | 0.85 | 83.75 |
| n-6/n-3 | 138 | 2.2 | 5.9 | 0.53 | 49.06 |
| AGS/n-3 | 136 | 7.9 | 22.2 | 1.63 | 80.04 |

AGS = saturated fatty acids;
AGMI = Monosaturated fatty acids;
AGPI = polyunsaturated fatty acid
RMSEP = Root Mean Square Error Prediction

f) External Validation

The robustness, i.e., validity of the equations (or the prediction model) determined previously is then tested by using samples that were not used for developing the calibration. It is a matter of determining the difference between the values predicted by the model on these samples and the actual values of the fatty acids considered and measured by GPC. The smaller the deviation, the more robust the model. This step can only be done with calibrations already developed from a sufficiently furnished database representative of practices in the field.

g) Conclusion:

In terms of this first step, it is possible to list the fatty acids that can be quantified reliably, precisely and robustly from an infrared measurement of a type of sample of tissue or meat.

In the case of the pork rib, the fatty acids could be listed as being measurable by acquisition of the infrared spectrum of the sample, i.e., for which the correlation coefficient is greater than 0.7, preferably 0.8, are: the sum of the saturated and mono-unsaturated fatty acids, the C16:0, the sum of the omega 6 and omega 3 fatty acids, C18:2 n-6 and C18:3 n-3.

This list is not exhaustive and may be changed (by addition or subtraction of fatty acids) progressively with the incrementation of new data that would extend the database to obtain a better representation of the production considered.

For other fatty acids not predictable by infrared, i.e., those for which the correlation coefficient does not exceed 0.7, or preferably 0.8, it is possible to determine their contents from statistical study of the correlation and prediction with the fatty acids previously determined by infrared.

Step 2: Determination of Minor Fatty Acids by Mathematical Prediction Equation within the Same Tissue

This step, from the database used to create the spectroscopic calibrations and/or the database ideally representative of the production considered, highlights statistical correlations and establishes prediction equations for fatty acids that cannot be measured by spectroscopy by their fatty acids contents that can be measured by spectroscopy.

The results presented in Tables 2 to 5 are obtained on pork ribs. Tables 2 and 3 respectively show the correlations and predictions between fatty acids expressed in % of the total fatty acids, Tables 4 and 5, between fatty acids expressed in mg per 100 g of tissue.

For example:

If the spectroscopic method allows determining MUFA but not C18:1 n-9, then, if the correlation between MUFA and C18:1 n-9 is highly significant (probability P<0.001), it becomes possible to determine the C18:1 n-9 by a prediction equation.

If the measurement of fatty acids is expressed in % of the total fatty acids, then the equation resulting from Table 2 is:

C18:1 n-9=1.02*MUFA-5.64

More elaborately, it is also possible to predict a fatty acid by an equation with several unknowns. For example, it is completely possible to determine the sum of the long chain omega 3 fatty acids (LCPUFA n-3), i.e., those whose carbon number is higher than 18, by the following equation:

LCPUFA n-3=PUFA n-3-C18:3 n-3

The results presented in Tables 6 to 9 are obtained on cattle muscle. Tables 6 and 7 respectively show the correlations and predictions between fatty acids expressed in % of the total fatty acids, Tables 8 and 9, between fatty acids expressed in mg per 100 g of product.

Other tables may also be made up for other tissues, and other species of animals.

Moreover, if the spectroscopic method allows determining some fatty acids (or families of fatty acids) of a given tissue, but does not allow determining these same fatty acids in other tissues of the same animal (which, for example, contain less by absolute value), the method offers a 3^{rd} step.

Step 3: Prediction of the Fatty Acid Contents of Different Tissues from the Fatty Acid Profile of a Single Tissue.

As before, at this step it is a question of using equations resulting from the best correlations for determining a given fatty acid (or family of fatty acids) from one or more tissues from its content in another tissue, resulting from step 1 or step 2.

By using databases made up of fatty acid profiles (determined by GPC) of different tissues from the same animal, correlations among tissues for each fatty acid were created.

The results presented in Tables 10 and 11 are obtained on C18:3 n-3 of different tissues respectively from pigs and cattle.

For example, at the end of step 1:

If the C18:3 n-3 is determined by spectroscopy on pig back fat, then it is possible to determine the pig semimembranosus (SM) C18:3 by the following equation: % C18:3 SM=0.49×% C18:3 back fat+0.11

If the C16:0 is determined by spectroscopy on the longissimus dorsi of young cattle, then it is possible to determine the C16:0 of cattle skirt steak by the following equation: % C16:0 skirt steak=4.59+0.82×% C16 longissimus dorsi

By possibly adding the idea of time:

If the C18:3 n-3 is determined by spectroscopy on the pig plasma on day D, then it is possible to determine the C18:3 of the pork rib at slaughter (D+30), with the condition that the diet is unchanged, by the following equation:

% C18:3 pork rib=0.58×% C18:3 plasma+0.36

For example, at the end of step 2: If the C16:0 of the longissimus dorsi of the young cattle is determined by spectroscopy in % of total FA, then it is possible:
a. to determine the C18:3 n-3 of the longissimus dorsi by the following equation:

C18:3 longissimus dorsi=3.25-0.1×C16:0 longissimus dorsi
b. to determine the C18:3 n-3 of the skirt steak by the following equation:

C18:3 skirt steak=0.22+0.62×C18:3 longissimus dorsi

By means of the proposed method, it is possible to quickly know the nutritional quality of fats and meats, and any meat product, for any animal species, when reliable prediction equations supplement spectroscopic analysis performed on at least one tissue of the animal, dead (fat cover, internal fat, intramuscular fat, etc.) or alive (blood, skin, fur, etc.) and whose fatty acids that are predicted by the equation would be more accurate than spectroscopy.

TABLE 2
Example of an inter-fatty acid correlation matrix (r²) (in % of total fatty
acids) obtained in the pork rib (n = 107). In italics, the significant relationships at
the threshold of 0.001%.

| | C18:3n-3 | AGS | AGM | AGP1 | n-6 | n-3 | C16:0 |
|---|---|---|---|---|---|---|---|
| C18:3n-3 | r² = 1.00 | r² = 0.24 | r² = 0.54 | r² = 0.62 | r² = 0.05 | r² = 0.94 | r² = 0.45 |
| AGS1 | r² = 0.24 | r² = 1.00 | r² = 0.07 | r² = 0.49 | r² = 0.05 | r² = 0.33 | r² = 0.70 |
| AGM | r² = 0.54 | r² = 0.07 | r² = 1.00 | r² = 0.77 | r² = 0.04 | r² = 0.61 | r² = 0.35 |
| AGPI | r² = 0.62 | r² = 0.49 | r² = 0.77 | r² = 1.00 | r² = 0.07 | r² = 0.75 | r² = 0.73 |
| n-6 | r² = 0.05 | r² = 0.05 | r² = 0.04 | r² = 0.07 | r² = 1.00 | r² = 0.04 | r² = 0.00 |
| n-3 | r² = 0.94 | r² = 0.33 | r² = 0.61 | r² = 0.75 | r² = 0.04 | r² = 1.00 | r² = 0.62 |
| C16:0 | r² = 0.45 | r² = 0.70 | r² = 0.35 | r² = 0.73 | r² = 0.00 | r² = 0.62 | r² = 1.00 |
| C16:1n-7 | r² = 0.46 | r² = 0.11 | r² = 0.35 | r² = 0.36 | r² = 0.08 | r² = 0.55 | r² = 0.50 |
| C18:1n-9c | r² = 0.52 | r² = 0.11 | r² = 0.89 | r² = 0.76 | r² = 0.01 | r² = 0.66 | r² = 0.43 |
| C18:2n-6c | r² = 0.08 | r² = 0.00 | r² = 0.00 | r² = 0.00 | r² = 0.82 | r² = 0.13 | r² = 0.04 |
| C20:4n-6 | r² = 0.01 | r² = 0.15 | r² = 0.06 | r² = 0.14 | r² = 0.12 | r² = 0.01 | r² = 0.19 |
| C20:5n-3 | r² = 0.24 | r² = 0.35 | r² = 0.29 | r² = 0.48 | r² = 0.00 | r² = 0.43 | r² = 0.51 |
| C22:5n-3 | r² = 0.60 | r² = 0.26 | r² = 0.40 | r² = 0.52 | r² = 0.01 | r² = 0.62 | r² = 0.40 |
| C22:6n-3 | r² = 0.01 | r² = 0.12 | r² = 0.07 | r² = 0.13 | r² = 0.02 | r² = 0.04 | r² = 0.16 |
| | C16:1n-7 | C18:1n-9c | C18:2n-6c | C20:4n-6 | C20:5n-3 | C22:5n-3 | C22:6n-3 |
| C18:3n-3 | r² = 0.46 | r² = 0.52 | r² = 0.08 | r² = 0.01 | r² = 0.24 | r² = 0.60 | r² = 0.01 |
| AGS1 | r² = 0.11 | r² = 0.11 | r² = 0.00 | r² = 0.15 | r² = 0.35 | r² = 0.26 | r² = 0.12 |
| AGM | r² = 0.35 | r² = 0.89 | r² = 0.00 | r² = 0.06 | r² = 0.29 | r² = 0.40 | r² = 0.07 |
| AGPI | r² = 0.36 | r² = 0.76 | r² = 0.00 | r² = 0.14 | r² = 0.48 | r² = 0.52 | r² = 0.13 |
| n-6 | r² = 0.08 | r² = 0.01 | r² = 0.82 | r² = 0.12 | r² = 0.00 | r² = 0.01 | r² = 0.02 |
| n-3 | r² = 0.55 | r² = 0.66 | r² = 0.13 | r² = 0.01 | r² = 0.43 | r² = 0.62 | r² = 0.04 |
| C16:0 | r² = 0.50 | r² = 0.43 | r² = 0.04 | r² = 0.19 | r² = 0.51 | r² = 0.40 | r² = 0.16 |
| C16:1n-7 | r² = 1.00 | r² = 0.43 | r² = 0.16 | r² = 0.00 | r² = 0.23 | r² = 0.22 | r² = 0.00 |
| C18:1n-9c | r² = 0.43 | r² = 1.00 | r² = 0.03 | r² = 0.12 | r² = 0.44 | r² = 0.44 | r² = 0.11 |
| C18:2n-6c | r² = 0.16 | r² = 0.03 | r² = 1.00 | r² = 0.00 | r² = 0.12 | r² = 0.05 | r² = 0.01 |
| C20:4n-6 | r² = 0.00 | r² = 0.12 | r² = 0.00 | r² = 1.00 | r² = 0.33 | r² = 0.03 | r² = 0.29 |
| C20:5n-3 | r² = 0.23 | r² = 0.44 | r² = 0.12 | r² = 0.33 | r² = 1.00 | r² = 0.30 | r² = 0.17 |
| C22:5n-3 | r² = 0.22 | r² = 0.44 | r² = 0.05 | r² = 0.03 | r² = 0.30 | r² = 1.00 | r² = 0.20 |
| C22:6n-3 | r² = 0.00 | r² = 0.11 | r² = 0.01 | r² = 0.29 | r² = 0.17 | r² = 0.20 | r² = 1.00 |

TABLE 3
Inter-fatty acid prediction equation matrix (in % of total fatty acids) obtained
in the pork rib (n = 107). Equation of type Y = aX + b. In italics,
the significant relationships at the threshold of 0.001%.

| | X | | | | | | |
|---|---|---|---|---|---|---|---|
| Y | C18:3n-3 | AGS | AGM | AGPI | n-6 | n-3 | C16:0 |
| C18:3n-3 | | Y = −0.63X + | Y = −0.63X + | Y = 0.50X − | Y = −0.35X + | Y = 0.71X + | Y = −0.99X + |
| | | 28.76 | 30.17 | 5.43 | 8.07 | 0.03 | 27.28 |
| AGS | Y = −0.38X + | | Y = 0.18X + | Y = −0.35X + | Y = −0.27X + | Y = −0.33X + | Y = 0.97X + |
| | 41.12 | | 32.14 | 45.99 | 42.99 | 41.41 | 16.71 |
| AGM | Y = −0.86X + | Y = 0.41X + | | Y = −0.65X + | Y = −0.35X + | Y = −0.67X + | Y = 1.03X + |
| | 45.29 | 25.94 | | 54.01 | 46.37 | 45.56 | 17.74 |
| AGPI | Y = 1.24X + | Y = −1.41X + | Y = −1.18X + | | Y = 0.62X + | Y = 1.00X + | Y = −1.99X + |
| | 13.59 | 74.06 | 67.86 | | 10.64 | 13.03 | 65.55 |
| n-6 | Y = −0.15X + | Y = −0.20X + | Y = −0.11X + | Y = 0.11X + | | Y = −0.10X + | Y = −0.06X + |
| | 12.78 | 19.96 | 16.95 | 10.18 | | 12.74 | 13.70 |
| n-3 | Y = 1.31X + | Y = −1.00X + | Y = −0.90X + | Y = 0.75X − | Y = −0.43X + | | Y = −1.58X + |
| | 0.28 | 44.96 | 43.21 | 8.43 | 10.49 | | 42.70 |
| C16:0 | Y = −0.45X + | Y = 0.73X − | Y = 0.34X + | Y = −0.37X + | Y = −0.07X + | Y = −0.39X + | |
| | 25.41 | 5.09 | 9.42 | 30.42 | 24.52 | 25.76 | |
| C16:1n-7 | Y = −0.12X + | Y = 0.08X − | Y = 0.09X − | Y = −0.07X + | Y = 0.08X + | Y = −0.10X + | Y = 0.19X − |
| | 2.35 | 1.19 | 2.00 | 3.16 | 0.91 | 2.40 | 2.67 |
| C18:1n-9c | Y = −0.91X + | Y = 0.54X + | Y = 1.02X − | Y = −0.70X + | Y = −0.14X + | Y = −0.76X + | Y = 1.23X + |
| | 40.72 | 15.69 | 5.64 | 50.08 | 39.07 | 41.24 | 8.01 |
| C18:2n-6c | Y = −0.19X + | Y = −0.01X + | Y = −0.01X + | Y = 0.01X + | Y = 0.92X − | Y = −0.18X + | Y = 0.21X + |
| | 11.87 | 11.57 | 11.47 | 11.01 | 0.07 | 12.07 | 6.12 |
| C20:4n-6 | Y = −0.01X + | Y = −0.07X + | Y = −0.03X + | Y = 0.04X − | Y = 0.08X − | Y = 0.01X + | Y = −0.10X + |
| | 0.67 | 3.58 | 1.93 | 0.02 | 0.32 | 0.56 | 2.90 |
| C20:5n-3 | Y = 0.05X + | Y = −0.07X + | Y = −0.04X + | Y = 0.04X − | Y = 0.00X + | Y = 0.05X − | Y = −0.10X + |
| | 0.06 | 3.19 | 2.13 | 0.54 | 0.28 | 0.00 | 2.71 |
| C22:5n-3 | Y = 0.03X + | Y = −0.03X + | Y = −0.02X + | Y = 0.02X − | Y = −0.01X + | Y = 0.03X + | Y = −0.04X + |
| | 0.11 | 1.38 | 1.23 | 0.12 | 0.32 | 0.11 | 1.21 |
| C22:6n-3 | Y = 0.00X + | Y = −0.01X + | Y = 0.00X + | Y = 0.00X − | Y = 0.00X + | Y = 0.00X + | Y = −0.01X + |
| | 0.04 | 0.34 | 0.20 | 0.03 | 0.00 | 0.03 | 0.29 |
| | X | | | | | | |
| Y | C16:1n-7 | C18:1n-9c | C18:2n-6c | C20:4n-6 | C20:5n-3 | C22:5n-3 | C22:6n-3 |
| C18:3n-3 | Y = −3.71X + | Y = −0.57X + | Y = −0.43X + | Y = −0.49X + | Y = 5.01X + | Y = 17.74X − | Y = 4.95X + |
| | 10.73 | 25.02 | 8.53 | 4.06 | 2.53 | 0.53 | 3.53 |
| AGS | Y = 1.39X + | Y = 0.21X + | Y = −0.01X + | Y = −2.05X + | Y = −4.69X + | Y = −9.16X + | Y = −15.69X + |
| | 37.07 | 31.98 | 39.85 | 40.98 | 40.83 | 41.90 | 40.40 |
| AGM | Y = 3.76X + | Y = 0.88X + | Y = −0.02X + | Y = −1.93X + | Y = −6.41X + | Y = −16.89X + | Y = −17.73X + |
| | 34.99 | 9.38 | 42.32 | 43.27 | 43.62 | 46.13 | 42.86 |
| AGPI | Y = −5.16X + | Y = −1.08X + | Y = 0.04X + | Y = 3.98X + | Y = 11.10X + | Y = 26.05X + | Y = 33.42X + |
| | 27.93 | 58.65 | 17.82 | 15.75 | 15.55 | 11.96 | 16.74 |
| n-6 | Y = 1.03X + | Y = −0.04X + | Y = 0.89X + | Y = 1.54X + | Y = −0.15X + | Y = −1.50X + | Y = 5.00X + |
| | 10.27 | 13.68 | 2.32 | 11.23 | 12.24 | 12.56 | 11.98 |
| n-3 | Y = −5.49X + | Y = −0.87X + | Y = −0.73X + | Y = 1.04X + | Y = 9.11X + | Y = 24.55X − | Y = 15.65X + |
| | 15.51 | 37.70 | 13.30 | 4.55 | 2.99 | 0.71 | 4.50 |
| C16:0 | Y = 2.60X + | Y = 0.35X + | Y = 0.21X + | Y = −1.98X + | Y = −4.93X + | Y = −9.76X + | Y = −15.86X + |
| | 18.85 | 10.61 | 21.36 | 24.96 | 24.92 | 26.08 | 24.44 |
| C16:1n-7 | | Y = 0.10X − | Y = 0.11X + | Y = 0.00X + | Y = −0.90X + | Y = −1.96X + | Y = −0.47X + |
| | | 1.67 | 0.66 | 1.88 | 2.10 | 2.35 | 1.90 |
| C18:1n-9c | Y = 4.52X + | | Y = 0.33X + | Y = −3.00X + | Y = −8.58X + | Y = −19.24X + | Y = −24.99X + |
| | 28.82 | | 33.65 | 39.18 | 39.39 | 41.94 | 38.43 |
| C18:2n-6c | Y = 1.48X + | Y = 0.09X − | | Y = −0.27X + | Y = −2.39X + | Y = −3.51X + | Y = −4.22X + |
| | 8.36 | 7.67 | | 11.31 | 11.72 | 11.99 | 11.33 |
| C20:4n-6 | Y = 0.00X + | Y = −0.04X + | Y = −0.01X + | | Y = 0.87X + | Y = 0.57X + | Y = 4.67X + |
| | 0.63 | 2.17 | 0.77 | | 0.42 | 0.49 | 0.42 |
| C20:5n-3 | Y = −0.26X + | Y = −0.05X + | Y = −0.05X + | Y = 0.38X + | | Y = 1.23X − | Y = 2.38X + |
| | 0.72 | 2.17 | 0.81 | 0.01 | | 0.05 | 0.14 |
| C22:5n-3 | Y = −0.11X + | Y = −0.02X + | Y = −0.01X + | Y = 0.05X + | Y = 0.24X + | | Y = 1.15X + |
| | 0.45 | 1.09 | 0.41 | 0.21 | 0.18 | | 0.19 |
| C22:6n-3 | Y = 0.00X + | Y = 0.00X + | Y = 0.00X + | Y = 0.06X + | Y = 0.07X + | Y = 0.17X + | |
| | 0.05 | 0.21 | 0.08 | 0.01 | 0.03 | 0.00 | |

TABLE 4
Example of an inter-fatty acid correlation matrix (r²) (in mg/100 g) obtained in
the pork rib. In italics, the significant relationships at the threshold of 0.001%.

| | C18:3n-3 | AGS | AGM | AGPI | n-6 | n-3 | C16:0 |
|---|---|---|---|---|---|---|---|
| C18:3n-3 | r² = 1.00 | r² = 0.21 | r² = 0.13 | r² = 0.70 | r² = 0.22 | r² = 0.95 | r² = 0.15 |
| AGS | r² = 0.21 | r² = 1.00 | r² = 0.95 | r² = 0.52 | r² = 0.79 | r² = 0.22 | r² = 0.98 |
| AGM | r² = 0.13 | r² = 0.95 | r² = 1.00 | r² = 0.42 | r² = 0.74 | r² = 0.14 | r² = 0.96 |
| AGPI | r² = 0.70 | r² = 0.52 | r² = 0.42 | r² = 1.00 | r² = 0.67 | r² = 0.80 | r² = 0.42 |
| n-6 | r² = 0.22 | r² = 0.79 | r² = 0.74 | r² = 0.67 | r² = 1.00 | r² = 0.25 | r² = 0.76 |
| n-3 | r² = 0.95 | r² = 0.22 | r² = 0.14 | r² = 0.80 | r² = 0.25 | r² = 1.00 | r² = 0.14 |
| C16:0 | r² = 0.15 | r² = 0.98 | r² = 0.96 | r² = 0.42 | r² = 0.76 | r² = 0.14 | r² = 1.00 |
| C16:1n-7 | r² = 0.00 | r² = 0.51 | r² = 0.57 | r² = 0.07 | r² = 0.42 | r² = 0.00 | r² = 0.62 |
| C18:1n-9c | r² = 0.12 | r² = 0.93 | r² = 0.99 | r² = 0.38 | r² = 0.73 | r² = 0.12 | r² = 0.96 |
| C18:2n-6c | r² = 0.18 | r² = 0.78 | r² = 0.76 | r² = 0.52 | r² = 0.94 | r² = 0.17 | r² = 0.79 |
| C20:4n-6 | r² = 0.02 | r² = 0.04 | r² = 0.03 | r² = 0.22 | r² = 0.14 | r² = 0.10 | r² = 0.02 |
| C20:5n-3 | r² = 0.30 | r² = 0.04 | r² = 0.02 | r² = 0.42 | r² = 0.09 | r² = 0.48 | r² = 0.01 |
| C22:5n-3 | r² = 0.71 | r² = 0.15 | r² = 0.10 | r² = 0.57 | r² = 0.16 | r² = 0.73 | r² = 0.10 |
| C22:6n-3 | r² = 0.02 | r² = 0.00 | r² = 0.00 | r² = 0.08 | r² = 0.01 | r² = 0.06 | r² = 0.00 |
| | C16:1n-7 | C18:1n-9c | C18:2n-6c | C20:4n-6 | C20:5n-3 | C22:5n-3 | C22:6n-3 |
| C18:3n-3 | r² = 0.00 | r² = 0.12 | r² = 0.18 | r² = 0.02 | r² = 0.30 | r² = 0.71 | r² = 0.02 |
| AGS | r² = 0.51 | r² = 0.93 | r² = 0.78 | r² = 0.04 | r² = 0.04 | r² = 0.15 | r² = 0.00 |
| AGM | r² = 0.57 | r² = 0.99 | r² = 0.76 | r² = 0.03 | r² = 0.02 | r² = 0.10 | r² = 0.00 |
| AGPI | r² = 0.07 | r² = 0.38 | r² = 0.52 | r² = 0.22 | r² = 0.42 | r² = 0.57 | r² = 0.08 |
| n-6 | r² = 0.42 | r² = 0.73 | r² = 0.94 | r² = 0.14 | r² = 0.09 | r² = 0.16 | r² = 0.01 |
| n-3 | r² = 0.00 | r² = 0.12 | r² = 0.17 | r² = 0.10 | r² = 0.48 | r² = 0.73 | r² = 0.06 |
| C16:0 | r² = 0.62 | r² = 0.96 | r² = 0.79 | r² = 0.02 | r² = 0.01 | r² = 0.10 | r² = 0.00 |
| C16:1n-7 | r² = 1.00 | r² = 0.60 | r² = 0.50 | r² = 0.00 | r² = 0.03 | r² = 0.00 | r² = 0.00 |
| C18:1n-9c | r² = 0.60 | r² = 1.00 | r² = 0.77 | r² = 0.02 | r² = 0.01 | r² = 0.08 | r² = 0.00 |
| C18:2n-6c | r² = 0.50 | r² = 0.77 | r² = 1.00 | r² = 0.02 | r² = 0.01 | r² = 0.11 | r² = 0.00 |
| C20:4n-6 | r² = 0.00 | r² = 0.02 | r² = 0.02 | r² = 1.00 | r² = 0.41 | r² = 0.06 | r² = 0.31 |
| C20:5n-3 | r² = 0.03 | r² = 0.01 | r² = 0.01 | r² = 0.41 | r² = 1.00 | r² = 0.34 | r² = 0.19 |
| C22:5n-3 | r² = 0.00 | r² = 0.08 | r² = 0.11 | r² = 0.06 | r² = 0.34 | r² = 1.00 | r² = 0.19 |
| C22:6n-3 | r² = 0.00 | r² = 0.00 | r² = 0.00 | r² = 0.31 | r² = 0.19 | r² = 0.19 | r² = 1.00 |

TABLE 5
Example of an inter-fatty acid correlation matrix (r²) (in % of total fatty
acids) obtained in the pork rib. In italics, the significant relationships at the
threshold of 0.0001%.

| | X | | | | | | |
|---|---|---|---|---|---|---|---|
| Y | C18:3n-3 | AGS | AGM | AGPI | n-6 | n-3 | C16:0 |
| C18:3n-3 | | Y = 0.11X − | Y = 0.08X + | Y = 0.36X − | Y = 0.42X − | Y = 0.71X + | Y = 0.16X + |
| | | 35.78 | 34.30 | 222.72 | 96.85 | 2.94 | 19.41 |
| AGS | Y = 1.88X + | | Y = 0.93X + | Y = 1.28X + | Y = 3.34X − | Y = 1.41X + | Y = 1.69X − |
| | 2772.45 | | 52.58 | 1397.77 | 31.86 | 2745.86 | 13.16 |
| AGM | Y = 1.58X + | Y = 1.02X + | | Y = 1.20X + | Y = 3.39X + | Y = 1.19X + | Y = 1.74X + |
| | 3064.21 | 128.29 | | 1709.57 | 105.13 | 3037.65 | 59.78 |
| AGPI | Y = 1.96X + | Y = 0.41X + | Y = 0.35X + | | Y = 1.74X − | Y = 1.53X + | Y = 0.63X + |
| | 914.34 | 181.80 | 309.35 | | 220.56 | 855.11 | 306.75 |
| n-6 | Y = 0.51X + | Y = 0.24X + | Y = 0.22X + | Y = 0.38X + | | Y = 0.40X + | Y = 0.39X + |
| | 857.61 | 228.66 | 243.11 | 426.48 | | 840.91 | 233.38 |
| n-3 | Y = 1.33X + | Y = 0.15X − | Y = 0.12X + | Y = 0.52X − | Y = 0.62X − | | Y = 0.21X + |
| | 20.84 | 52.08 | 42.67 | 349.35 | 169.61 | | 40.52 |
| C16:0 | Y = 0.93X + | Y = 0.58X + | Y = 0.55X + | Y = 0.67X + | Y = 1.92X + | Y = 0.67X + | |
| | 1715.21 | 46.20 | 45.91 | 968.44 | 47.13 | 1713.43 | |
| C16:1n-7 | Y = −0.01X − | Y = 0.03X + | Y = 0.03X + | Y = 0.02X + | Y = 0.11X + | Y = −0.01X + | Y = 0.06X + |
| | 158.39 | 44.56 | 36.66 | 123.15 | 40.43 | 160.36 | 31.74 |
| C18:1n-9c | Y = 1.31X + | Y = 0.89X + | Y = 0.88X + | Y = 1.01X + | Y = 2.98X + | Y = 0.95X + | Y = 1.54X + |
| | 2746.76 | 148.11 | 23.60 | 1599.74 | 123.38 | 2740.33 | 70.15 |
| C18:2n-6c | Y = 0.43X + | Y = 0.22X + | Y = 0.20X + | Y = 0.31X + | Y = 0.90X + | Y = 0.31X + | Y = 0.37X + |
| | 793.39 | 197.44 | 202.77 | 447.15 | 14.08 | 795.42 | 182.90 |
| C20:4n-6 | Y = 0.02X + | Y = 0.01X + | Y = 0.00X + | Y = 0.03X + | Y = 0.04X + | Y = 0.03X + | Y = 0.01X + |
| | 45.57 | 31.45 | 33.83 | 11.57 | 7.50 | 37.76 | 38.41 |
| C20:5n-3 | Y = 0.05X + | Y = 0.00X + | Y = 0.00X + | Y = 0.02X − | Y = 0.02X − | Y = 0.04X + | Y = 0.00X + |
| | 5.17 | 7.67 | 11.14 | 16.55 | 2.57 | 0.55 | 13.81 |
| C22:5n-3 | Y = 0.03X + | Y = 0.00X + | Y = 0.01X + | Y = 0.01X + | Y = 0.01X + | Y = 0.03X + | Y = 0.01X + |
| | 8.96 | 7.79 | 9.85 | 0.15 | 5.47 | 8.55 | 10.04 |
| C22:6n-3 | Y = 0.00X + | Y = 0.00X + 3.65 | Y = 0.00X + | Y = 0.00X + | Y = 0.00X + | Y = 0.00X + | Y = 0.00X + |
| | 2.93 | | 3.98 | 0.61 | 2.20 | 2.32 | 4.41 |

| | X | | | | | | |
|---|---|---|---|---|---|---|---|
| Y | C16:1n-7 | C18:1n-9c | C18:2n-6c | C20:4n-6 | C20:5n-3 | C22:5n-3 | C22:6n-3 |
| C18:3n-3 | Y = −0.20X + | Y = 0.09X + | Y = 0.42X − | Y = 1.11X + | Y = 6.27X + | Y = 21.12X − | Y = 8.45X + |
| | 369.81 | 53.00 | 53.03 | 281.35 | 203.11 | 91.08 | 307.90 |
| AGS | Y = 15.63X + | Y = 1.05X + | Y = 3.60X + | Y = 6.28X + | Y = 9.05X + | Y = 39.66X + | Y = −0.59X − |
| | 971.69 | 67.76 | 24.54 | 085.24 | 3214.06 | 2602.89 | 3411.58 |
| AGM | Y = 17.31X + | Y = 1.13X + | Y = 3.70X + | Y = 5.73X + | Y = 7.03X + | Y = 34.27X + | Y = −7.71X − |
| | 899.79 | 2.49 | 124.46 | 3303.84 | 3447.90 | 2902.54 | 3627.51 |
| AGPI | Y = 3.19X + | Y = 0.38X + | Y = 1.66X + | Y = 8.65X + | Y = 17.19X + | Y = 44.22X + | Y = 43.24X + |
| | 1078.97 | 365.72 | 19.49 | 1130.30 | 1205.54 | 677.26 | 1420.05 |
| n-6 | Y = 3.78X + | Y = 0.25X + | Y = 1.05X + | Y = 3.20X + | Y = 3.66X + | Y = 10.94X + | Y = 6.87X + |
| | 441.36 | 245.53 | 46.98 | 864.98 | 951.21 | 807.63 | 1005.30 |
| n-3 | Y = −0.49X + | Y = 0.12X + | Y = 0.55X − | Y = 3.40X + | Y = 10.78X + | Y = 29.36X − | Y = 21.26X + |
| | 547.20 | 82.45 | 46.97 | 295.41 | 238.31 | 126.02 | 394.18 |
| C16:0 | Y = 10.10X + | Y = 0.62X + | Y = 2.13X + | Y = 2.39X + | Y = 2.93X + | Y = 18.85X + | Y = −9.50X − |
| | 454.35 | 43.45 | 29.61 | 1906.85 | 1966.70 | 1646.57 | 2064.38 |
| C16:1n-7 | | Y = 0.04X + | Y = 0.13X + | Y = 0.10X + | Y = −0.36X + | Y = −0.20X + | Y = −0.68X − |
| | | 33.05 | 32.27 | 150.75 | 169.73 | 160.10 | 158.42 |
| C18:1n-9c | Y = 15.69X + | | Y = 3.30X + | Y = 3.78X + | Y = 3.94X + | Y = 26.89X + | Y = −16.84X + |
| | 741.45 | | 89.01 | 2993.88 | 3103.76 | 2642.13 | 3249.89 |
| C18:2n-6c | Y = 3.80X + | Y = 0.23X + | | Y = 1.20X + | Y = 1.29X + | Y = 8.47X + | Y = −2.67X − |
| | 346.11 | 192.68 | | 877.32 | 911.54 | 767.23 | 949.13 |
| C20:4n-6 | Y = 0.05X + | Y = 0.00X + | Y = 0.02X + | | Y = 0.92X + | Y = 0.75X + | Y = 4.53X + |
| | 44.55 | 38.29 | 33.99 | | 31.68 | 36.27 | 35.23 |
| C20:5n-3 | Y = −0.08X + | Y = 0.00X + | Y = 0.01X + | Y = 0.44X − | | Y = 1.28X − | Y = 2.44X + |
| | 33.73 | 14.92 | 12.51 | 1.25 | | 4.40 | 12.76 |
| C22:5n-3 | Y = −0.01X + | Y = 0.00X + | Y = 0.01X + | Y = 0.07X + | Y = 0.26X + | | Y = 1.10X + |
| | 21.75 | 10.99 | 8.11 | 16.50 | 14.66 | | 16.35 |
| C22:6n-3 | Y = 0.00X + | Y = 0.00X + | Y = 0.00X + | Y = 0.07X + | Y = 0.08X + | Y = 0.17X + | |
| | 4.34 | 4.52 | 4.21 | 0.10 | 1.97 | 0.20 | |

TABLE 6
Inter-fatty acid prediction equation matrix (in % of total fatty acids) obtained
in the longissimus dorsi of young cattle (n = 110). Equation of type Y = aX + b. In
italics, the significant relationships at the threshold of 0.0001%.

| | | | | | | | | C 18:1 et | C 18:2 | C 18:3 | C 20:4 | C 20:5 | C 22:5 | C 22:6 |
|---|---|---|---|---|---|---|---|---|---|---|---|---|---|---|
| | AGS | AGMI | AGPI | AGPI n-3 | AGPIn-6 | C 16:0 | C 16:1 | isomere | n-6 | n-3 | n-6 | n-3 | n-3 | n-3 |
| AGS | 1 | −0.46 | −0.56 | −0.19 | −0.59 | 0.49 | −0.23 | −0.46 | −0.63 | −0.09 | −0.33 | −0.17 | −0.19 | −0.39 |
| AGMI | −0.46 | 1 | −0.48 | −0.63 | −0.41 | 0.36 | 0.75 | 0.99 | −0.37 | −0.53 | −0.59 | −0.59 | −0.64 | −0.52 |
| AGPI | −0.56 | −0.48 | 1 | 0.77 | 0.97 | −0.82 | −0.47 | −0.47 | 0.96 | 0.59 | 0.87 | 0.68 | 0.79 | 0.76 |
| AGPI n-3 | −0.19 | −0.63 | 0.77 | 1 | 0.61 | −0.59 | −0.51 | −0.62 | 0.60 | 0.92 | 0.67 | 0.73 | 0.83 | 0.70 |
| AGPI n-6 | −0.59 | −0.41 | 0.97 | 0.61 | 1 | −0.77 | −0.40 | −0.41 | 1.00 | 0.41 | 0.89 | 0.60 | 0.70 | 0.76 |
| C 16:0 | 0.49 | 0.36 | −0.82 | −0.59 | −0.77 | 1 | 0.65 | 0.29 | −0.79 | −0.46 | −0.64 | −0.54 | −0.59 | −0.63 |
| C 16:1 | −0.23 | 0.75 | −0.47 | −0.51 | −0.40 | 0.65 | 1 | 0.65 | −0.38 | −0.43 | −0.47 | −0.54 | −0.54 | −0.52 |
| C 18:1 et | −0.46 | 0.99 | −0.47 | −0.62 | −0.41 | 0.29 | 0.65 | 1 | −0.37 | −0.53 | −0.59 | −0.56 | −0.63 | −0.49 |
| isomere | | | | | | | | | | | | | | |
| C 18:2 n-6 | −0.63 | −0.37 | 0.96 | 0.60 | 1.00 | −0.79 | −0.38 | −0.37 | 1 | 0.40 | 0.84 | 0.56 | 0.66 | 0.75 |
| C 18:3 n-3 | −0.09 | −0.53 | 0.59 | 0.92 | 0.41 | −0.46 | −0.43 | −0.53 | 0.40 | 1 | 0.43 | 0.46 | 0.59 | 0.53 |
| C 20:4 n-6 | −0.33 | −0.59 | 0.87 | 0.67 | 0.89 | −0.64 | −0.47 | −0.59 | 0.84 | 0.43 | 1 | 0.76 | 0.85 | 0.73 |
| C 20:5 n-3 | −0.17 | −0.59 | 0.68 | 0.73 | 0.60 | −0.54 | −0.54 | −0.56 | 0.56 | 0.46 | 0.76 | 1 | 0.92 | 0.85 |
| C 22:5 n-3 | −0.19 | −0.64 | 0.79 | 0.83 | 0.70 | −0.59 | −0.54 | −0.63 | 0.66 | 0.59 | 0.85 | 0.92 | 1 | 0.81 |
| C 22:6 n-3 | −0.39 | −0.52 | 0.76 | 0.70 | 0.76 | −0.63 | −0.52 | −0.49 | 0.75 | 0.53 | 0.73 | 0.85 | 0.81 | 1 |

TABLE 7
Example of an inter-fatty acid correlation matrix (r²) (in mg/100 g) obtaned in
the longissimus dorsi of young cattle (n = 110). In italics, the significant
relationships at the threshold of 0.001%.

| | | | | | | | | C 18:1et | |
|---|---|---|---|---|---|---|---|---|---|
| | AGS | AGMI | AGPI | AGPI n-3 | AGPI n-6 | C 16:0 | C 16:1 | isomere | C 18:2 n-6 |
| AGS | | AGMI = | AGPI = | AGPI n-3 = | AGPIn-6 = | C 16:0 = | C 16:1 = | C 18:1et | C 18:2 n-6 = |
| | | 61.688 − .4352 * | 38.116 − .5568 * | 3.7188 − .0425 * | 30.191 − .4593 * | 5.9553 + | 3.9942 − .0328 * | isomere = 54.591 − | 26.063 − .4005 * |
| | | AGS | AGS | AGS | AGS | .33753 * AGS | AGS | .3669 * AGS | AGS |
| AGMI | AGMI = | | AGPI = | AGPI n-3 = | AGPIn-6 = | C 16:0 = | C 16:1 = −2.133 + | C 18:1et | C 18:2 n-6 = |
| | 61.688 − .4352 * | | 29.422 − .4968 * | 7.5146 − .1507 * | 20.023 − .3340 * | 12.847 + | .11278 * | isomere = 2.8012 + | 15.497 − .2482 * |
| | AGS | | AGMI | AGMI | AGMI | .26007 *AGMI | AGMI | .83763 * AGMI | AGMI |
| AGPI | AGPI = | AGPI = | | AGPIn-3 = −.1823 + | AGPIn-6 = −.5835 + | C 16:0 = | C 16:1 = | C 18:1et | C 18:2 n-6 = −.3919 + |
| | 38.116 − .5568 * | 29.422 − .4968 * | | .17759 * | .75682 * | 28.689 − .5683 * | 2.9861 − .0675 * | isomere = 39.631 − | .62113 * |
| | AGS | AGMI | | AGPI | AGPI | AGPI | AGPI | .3793 * AGPI | AGPI |
| AGPI n-3 | AGPI n-3 = | AGPI n-3 = | AGPI n-3 = −.1823 + | | AGPIn-6 = | C 16:0 = | C 16:1 = | C 18:1et | C 18:2 n-6 = |
| | 3.7188 − .0425 * | 7.5146 − .1507 * | 17759 * | | 3.5836 + | 25.907-1.786 * | 2.8247 − .3206 * | isomere = 39.330 − | 3.0790 + |
| | AGS | AGMI | AGPI | | 2.0807 * AGPI | AGPI n-3 | AGPI n-3 | 2.193 * AGPI n-3 | 1.6749 * AGPI |
| | | | | | n-3 | | | | n-3 |
| AGPI n-6 | AGPIn-6 = | AGPIn-6 = | AGPIn-6 = −.5835 + | AGPIn-6 = | | C 16:0 = | C 16:1 = | C 18:1et | C 18:2 n-6 = |
| | 30.191 − .4593 * | 20.023 − .3340 * | .75682 * | 3.5836 + | | 27.806 − .6856 * | 2.8291 − .0737 | isomere = 38.789 − | .10273 + |
| | AGS | AGMI | AGPI | 2.0807 * AGPI | | AGPIn-6 | AGPIn-6 | .4206 * AGPIn-6 | .81840 * |
| | | | | n-3 | | | | | AGPIn-6 |
| C 16:0 | C 16:0 = | C 16:0 = | C 16:0 = | C 16:0 = | C 16:0 = | | C 16:1 = −.8025 + | C 18:1et isomere = | C 18:2 n-6 = |
| | 5.9553 + | 12.847 + | 28.689 − .5683 * | 25.907-1.786 * | 27.806 − .6856 * | | .8025 + .13527 * | 28.060 + .33988 * | 22.598 − .7313 * |
| | .33753 * AGS | 26007 *AGMI | AGPI | AGPI n-3 | AGPIn-6 | | C 16:0 | C 16:0 | C 16:0 |
| C 16:1 | C 16:1 = | C 16:1 = −2.133 + | C 16:1 = | C 16:1 = | C 16:1 = | C 16:1 = −.8025 + | | C 18:1et | C 18:2 n-6 = |
| | 3.9942 − .0328 * | 2.133 + .11278 * | 2.9861 − .0675 * | 2.8247 − .3206 * | 2.8291 − .0737 * | 8025 + | | isomere = 27.437 + | 9.6419-1.702 * |
| | AGS | AGMI | AGPI | AGPI n-3 | AGPIn-6 | .13527 * C | | 3.6473 * C 16:1 | C 16:1 |
| | | | | | | 16:0 | | | |
| C 18:1 et | C 18:1et | C 18:1et | C 18:1et | C 18:1et | C 18:1et | C 18:1et | C 18:1et | | C 18:2 n-6 = |
| isomere | isomere = | isomere = | isomere = | isomere = | isomere = | isomere = | isomere = | | 16.132 − .2909 * |
| | 54.591 − .3669 * | 2.8012 + | 39.631 − .3793 * | 39.330 − 2.193 * | 38.789 − .4206 * | 28.060 + | 27.437 + | | C 18:1et |
| | AGS | .83763 * AGMI | AGPI | AGPI n-3 | AGPIn-6 | .33988 * C | 3.6473 * C | | isomere |
| | | | | | | 16:0 | 16:1 | | |
| C 18:2 | C 18:2 n-6 = | C 18:2 n-6 = | C 18:2 n-6 = −.3919 + | C 18:2 n-6 = | C 18:2 n-6 = | C 18:2 n-6 = | C 18:2 n-6 = | C 18:2 n-6 = | |
| n-6 | 26.063 − .4005 * | 15.497 − .2482 * | .62113 * | 3.0790 + | .10273 + | 22.598 − .7313 * | 9.6419 − 1.702 * | 16.132 − .2909 * | |
| | AGS | AGMI | AGPI | 1.6749 * AGPI | .81840 * | C 16:0 | C 16:1 | C 18:1et isomere | |
| | | | | n-3 | AGPIn-6 | | | | |
| | | | | | AGPIn-6 | | | | |
| C 18:3 | C 18:3 n-3 = | C 18:3 n-3 = | C 18:3 n-3 = | C 18:3 n-3 = −.0202 + | C 18:3 n-3 = | C 18:3 n-3 = | C 18:3 n-3 = | C 18:3 n-3 = | C 18:3 n-3 = |
| n-3 | 1.6538 − .0142 * | 4.2578 − .0841 * | .05291 + | .61183 * | .39215 + | 3.2503 − .1003 * | 1.9750 − .4488 * | 4.4848 − .0989 * | .38865 + |
| | AGS | AGMI | .08978 * AGPI | AGPI n-3 | .07902 * | C 16:0 | C 16:1 | C 18:1 et isomere | .09542 * C 18:2 |
| | | | | | AGPIn-6 | | | | n-6 |
| C 20:4 | C 20:4 n-6 = | C 20:4 n-6 = | C 20:4 n-6 = −.2759 + | C 20:4 n-6 = | C 20:4 n-6 = −.1830 + | C 20:4 n-6 = | C 20:4 n-6 = | C 20:4 n-6 = | C 20:4 n-6 = −.1511 + |
| n-6 | 2.5465 − .0366 * | 3.4083 − .0689 * | .09811 * | .17905 + | .12711 * | 3.0698 − .1032 * | 1.5399 − .3681 * | 3.6138 − .0816 * | .14689 * |
| | AGS | AGMI | AGPI | .32459 * AGPI | * AGPIn-6 | * C 16:0 | C 16:1 | C 18:1et isomere | C 18:2 n-6 |
| | | | | n-3 | | | | | |
| C 20:5 | C 20:5 n-3 = | C 20:5 n-3 = | C 20:5 n−. 3 = −.0628 + | C 20:5 n-3 = −.0017 + | C 20:5 n-3 = −.0103 + | C 20:5 n-3 = | C 20:5 n-3 = | C 20:5 n-3 = | C 20:5 n-3 = −.4E−3 + |
| n-3 | .45689 − .0056 * | 1.0393 − .0221 * | .02346 * | .10842 | .02610 * | .76707 − .0258 * | .47196 − .1302 * | 1.0626 − .0250 * | .02968 * |
| | AGS | AGMI | AGPI | AGPI n-3 | AGPIn-6 | C 16:0 | C 16:1 | C 18:1et isomere | C 18:2 n-6 |
| C 22:5 | C 22:5 n-3 = | C 22:5 n-3 = | C 22:5 n-3 = −.1220 + | C 22:5 n-3 = −.0144 + | C 22:5 n-3 = −.0390 + | C 22:5 n-3 = | C 22:5 n-3 = | C 22:5 n-3 = | C 22:5 n-3 = −.0251 + |
| n-3 | .77009 − .0098 * | 1.6315 − .0343 * | .04045 * | 18530 * | .04586 * | 1.2798 − .0435 * | .71926 − .1916 * | 1.7096 − .0400 * | .05256 * |
| | AGS | AGMI | AGPI | AGPI n-3 | AGPIn-6 | * C 16:0 | C 16:1 | C 18:1et isomere | C 18:2 n-6 |
| C 22:6 | C 22:6 n-3 = | C 22:6 n-3 = | C 22:6 n-3 = | C 22:6 n-3 = | C 22:6 n-3 = | C 22:6 n-3 = | C22:6 n-3 = | C22:6 n-3 = | C22:6 n-3 = |
| n-3 | .50888 − .0066 * | .58860 − .0113 * | .01502 + | .07530 + | .01777 + | .55812 − .0179 * | .32969 − .0825 * | .60631 −.0129 * | .01749 + |
| | AGS | AGMI | .01267 * AGPI | .04432 *AGPI | .01791 * | C 16:0 | C 16:1 | C 18:1et isomere | .02190 * C 18:2 |
| | | | | n-3 | AGPIn-6 | | | | n-6 |

| | C 18:3 n-3 | C 20:4 n-6 | C 20:5 n-3 | C 22:5 n-3 | C 22:6 n-3 |
|---|---|---|---|---|---|
| AGS | C 18:3 n-3 = | C 20:4 n-6 = | C 20:5 n-3 = | C 22:5 n-3 = | C 22:6 n-3 = |
| | 1.6538 − .0142 * | 25465 − .0366 * | .45689 − .0056 * | .77009 − .0098 * | .50888 − .0066 |
| | AGS | AGS | AGS | AGS | AGS |
| AGMI | C 18:3 n-3 = | C 20:4 n-6 = | C 20:5 n-3 = | C 22:5 n-3 = | C 22:6 n-3 = |
| | 4.2578 − .0841 * | 3.4083 − .0689 * | 1.0393 − .0221 * | 1.6315 − .0343 * | .58860 − .0113 * |
| | AGMI | AGMI | AGMI | AGMI | AGMI |
| AGPI | C 18:3 n-3 = | C 20:4 n-6 = −.2759 + | C 20:5 n-3 = −.0628 + | C 22:5 n-3 = −.1220 + | C 22:6 n-3 = |
| | .05291 + | .09811 * | .02346 * | .04045 * | .01502 + |
| | .08978 * AGPI | AGPI | AGPI | AGPI | .01267 * AGPI |
| AGPI n-3 | C 18:3 n-3 = −.0202 + | C 20:4 n-6 = | C20:5 n-3 = −.0017 + | C22:5 n-3 = −.0144 + | C 22:6 n-3 = |
| | .61183 | .17905 + | .10842 * | .18530 * | .07530 + |
| | AGPI n-3 | .32459 * AGPI | AGPI n-3 | AGPI n-3 | .04432 * AGPI |
| | | n-3 | | | n-3 |
| AGPI n-6 | C 18:3 n-3 = | C 20:4 n-6 = −.1830 + | C 20:5 n-3 = −.0103 + | C 22:5 n-3 = −.0390 + | C 22:6 n-3 = |
| | .39215 + | .12711 * | .02610 * | .04586 * | .01777 + |
| | .07902 * | AGPIn-6 | AGPIn-6 | AGPIn-6 | .01791 * |
| | AGPIn-6 | | | | AGPIn-6 |
| C 16:0 | C 18:3 n-3 = | C20:4 n-6 = | C20:5 n3 = | C22:5 n-3 = | C22:6 n-3 = |
| | 3.2503 − .1003 * | 3.0698 − .1032 * | .76707 − .0258 * | 1.2798 − .0435 * | .55812 − .0179 * |
| | C 16:0 | C 16:0 | C 16:0 | C 16:0 | C 16:0 |
| C 16:1 | C 18:3 n-3 = | C 20:4 n-6 = | C 20:5 n-3 = | C22:5 n-3 = | C 22:6 n-3 = |
| | 1.9750 − .4488 * | 1.5399 − .3681 * | .47196 − .1302 * | .71926 − .1916 * | .32969 − .0825 * |
| | C 16:1 | C 16:1 | C 16:1 | C 16:1 | C 16:1 |
| C 18:1 et | C 18:3 n-3 = | C 20:4 n-6 = | C 20:5 n-3 = | C 22:5 n-3 = | C22:6 n-3 = |
| isomere | 4.4848 − .0989 * | 3.6138 − .0816 * | 1.0626 − .0250 * | 1.7096 − .0400 * | 60631 − .0129 * |
| | C 18:1et | C 18:1et | C 18:1et | C 18:1et | C 18:1et |
| | isomere | isomere | isomere | isomere | isomere |
| C 18:2 | C 18:3 n-3 = | C 20:4 n-6 = −.1511 + | C 20:5 n-3 = −.4E−3 + | C 22:5 n-3 = −.0251 + | C 22:6 n-3 = |
| n-6 | .38865 + | .14689 * | .02968 * | .05256 * | .01749 + |
| | .09542 * C 18:2 | C 18:2 n-6 | C 18:2 n-6 | C 18:2 n-6 | .02190 * C |
| | n-6 | | | | 18:2 n-6 |
| C 18:3 | | C 20:4 n-6 = | C 20:5 n-3 = | C 22:5 n-3 = | C 22:6 n-3 = |
| n-3 | | .39008 + | .07463 + | .08704 + | .10920 + |
| | | .31535 * C 18:3 | .10256 * C 18:3 | .20045 * C 18:3 | .05407 * C |
| | | n-3 | n-3 | n-3 | 18:3 n-3 |
| C 20:4 | C 20:4 n-6 = | | C 20:5 n-3 = | C 22:5 n-3 = | C 22:6 n-3 = |
| n-6 | .39008 + .31535 * | | .00860 + | .00734 + | .06345 + |
| | C 18:3 | | .23044 * C 20:4 | .38953 * C 20:4 | .10558 * C |
| | n-3 | | n-6 | n-6 | 20:4 n-6 |
| C 20:5 | C 20:5 n-3 = | C 20:5 n-3 = | | C 22:5 n-3 = | C 22:6 n-3 = |
| n-3 | .07463 + | .00860 + | | .04103 + | .05821 + |
| | .10256 * C 18:3 | .23044 * C 20:4 | | 1.4086 * C 20:5 | .37095 * C |
| | n-3 | n-6 | | n-3 | 20:5 n-3 |
| C 22:5 | C 22:5 n-3 = | C 22:5 n-3 = | C 22:5 n-3 = | | C 22:6 n-3 = |
| n-3 | .08704 + | .00734 + | .04103 + | | .06052 + |
| | .20045 * C 18:3 | .38953 * C 20:4 | 1.4086 * C 20:5 | | .23537 * C |
| | n-3 | n-6 | n-3 | | 22:5 n-3 |
| C 22:6 | C 22:6 n-3 = | C 22:6 n-3 = | C 22:6 n-3 = | C 22:6 n-3 = | |
| n-3 | .10920 + | .06345 + | .05821 + | .06052 + | |
| | .05407 * C 18:3 | .10558 * C 20:4 | .37095 * C 20:5 | .23537 * C 22:5 | |
| | n-3 | n-6 | n-3 | n-3 | |

TABLE 8
Inter-fatty acid prediction equation matrix (in mg/100 g) obtained in the
longissimus dorsi of young cattle (n = 110). Equation of type Y = aX + b. In italics. the
significant relationships at the threshold of 0.001%.

| | | | | | | | C 18:1et | | | | | | |
|---|---|---|---|---|---|---|---|---|---|---|---|---|---|
| | AGS | AGMI | AGPI | AGPI n-3 | C 16:0 | C 16:1 | isomere | C 18:2 n-6 | C 18:3 n-3 | C 20:4 n-6 | C 20:5 n-3 | C 22:5 n-3 | C 22:6 n-3 |
| AGS | 1.00 | 0.27 | 0.10 | 0.10 | 0.34 | 0.41 | 0.46 | 0.09 | 0.05 | −0.06 | 0.23 | 0.03 | 0.03 |
| AGMI | 0.27 | 1.00 | 0.02 | 0.01 | 0.32 | 0.48 | 0.38 | 0.03 | 0.01 | 0.06 | 0.16 | 0.08 | 0.10 |
| AGPI | 0.10 | 0.02 | 1.00 | 0.23 | −0.01 | 0.08 | 0.08 | 0.40 | 0.25 | 0.30 | 0.31 | 0.33 | 0.24 |
| AGPI n-3 | 0.10 | 0.01 | 0.23 | 1.00 | 0.03 | 0.01 | 0.15 | 0.21 | 0.69 | 0.31 | 0.45 | 0.37 | 0.37 |
| C 16:0 | 0.34 | 0.32 | −0.01 | 0.03 | 1.00 | 0.46 | 0.38 | 0.13 | −0.06 | 0.01 | 0.07 | 0.01 | −0.01 |
| C 16:1 | 0.41 | 0.48 | 0.08 | 0.01 | 0.46 | 1.00 | 0.50 | 0.12 | 0.09 | 0.04 | 0.09 | 0.03 | 0.11 |
| C 18:1et | 0.46 | 0.38 | 0.08 | 0.15 | 0.38 | 0.50 | 1.00 | 0.10 | 0.09 | 0.04 | 0.21 | 0.04 | 0.27 |
| isomere | | | | | | | | | | | | | |
| C 18:2 n-6 | 0.09 | 0.03 | 0.40 | 0.21 | 0.13 | 0.12 | 0.10 | 1.00 | 0.18 | 0.41 | 0.54 | 0.43 | 0.49 |
| C 18:3 n-3 | 0.05 | 0.01 | 0.25 | 0.69 | −0.06 | 0.09 | 0.09 | 0.18 | 1.00 | 0.30 | 0.35 | 0.32 | 0.23 |
| C 20:4 n-6 | −0.06 | 0.06 | 0.30 | 0.31 | 0.01 | 0.04 | 0.04 | 0.41 | 0.30 | 1.00 | 0.52 | 0.57 | 0.21 |
| C 20:5 n-3 | 0.23 | 0.16 | 0.31 | 0.45 | 0.07 | 0.09 | 0.21 | 0.54 | 0.35 | 0.52 | 1.00 | 0.64 | 0.43 |
| C 22:5 n-3 | 0.03 | 0.08 | 0.33 | 0.37 | 0.01 | 0.03 | 0.04 | 0.43 | 0.32 | 0.57 | 0.64 | 1.00 | 0.43 |
| C 22:6 n-3 | 0.03 | 0.10 | 0.24 | 0.37 | −0.01 | 0.11 | 0.27 | 0.49 | 0.23 | 0.21 | 0.43 | 0.43 | 1.00 |

TABLE 9
Inter-fatty acid prediction equation matrix (in mg/100 g) obtained in the
longissimus dorsi of young cattle (n = 110). Equation of type Y = aX + b.
In italics, the significant relationships at the threshold of 0.001%.

| | AGS | AGMI | AGPI | AGPI n-3 | C 16:0 |
|---|---|---|---|---|---|
| AGS | | AGMI = | AGPI = | AGPI n-3 = | C 16:0 = |
| | | 471.37 + | 159.22 + | 27.584 + | 272.44 + |
| | | ,21747 * AGS | ,01271 * AGS | ,00234 * AGS | ,15168 * AGS |
| AGMI | | | AGPI = | AGPI n-3 = | C 16:0 = |
| | | | 169.47 + | 29.657 + ,35E−3 * | 298.48 + |
| | | | ,00332 * AGMI | AGMI | ,18006 * |
| | | | | | AGMI |
| AGPI | | | | AGPI n-3 = | C 16:0 = |
| | | | | 22.576 + | 429.03 − ,0412 * |
| | | | | ,04261 * AGPI | AGPI |
| AGPI n-3 | | | | | C 16:0 = |
| | | | | | 405.29 + |
| | | | | | ,55764 * AGPI |
| | | | | | n-3 |
| C 16:0 | | | | | |
| C 16:1 | | | | | |
| C 18:1et | | | | | |
| isomere | | | | | |
| C 18:2 n-6 | | | | | |
| C 18:3 n-3 | | | | | |
| C 20:4 n-6 | | | | | |
| C 20:5 n-3 | | | | | |
| C 22:5 n-3 | | | | | |
| C 22:6 n-3 | | | | | |

| | C 16:1 | C 18:1et isomere | C 18:2 n-6 | C 18:3 n-3 |
|---|---|---|---|---|
| AGS | C 16:1 = | RAK C 18:1et | C 18:2 n-6 = | C 18:3 n-3 = |
| | 28.865 + | isomere = 315.93 + | 93.723 + ,00605 * | 17.531 + ,89E−3 * |
| | ,01996 * AGS | ,34518 * AGS | AGS | AGS |
| AGMI | C 16:1 = | RAK C 18:1et | C 18:2 n-6 = | C 18:3 n-3 = |
| | 28.174 + | isomere = 411.06 + | 98.057 + ,00238 * | 18.218 + ,27E−3 * |
| | ,02970 * | ,35747 * AGMI | AGMI | AGMI |
| | AGMI | | | |
| AGPI | C 16:1 = | RAK C 18:1et isomere = | C 18:2 n-6 = | C 18:3 n-3 = |
| | 43.083 + | 576.89 + ,46170 * | 61.171 + ,22427 * | 12.560 + ,03403 * |
| | ,03176 * AGPI | AGPI | AGPI | AGPI |
| AGPI n-3 | C 16:1 = | RAK C 18:1et isomere = | C 18:2 n-6 = | C 18:3 n-3 = |
| | 47.722 + | 505.26 + 5.0488 * | 80.767 + ,63301 * | 3.5358 + ,49742 * |
| | ,02730 * AGPI | AGPI n-3 | AGPI n-3 | AGPI n-3 |
| | n-3 | | | |
| C 16:0 | C 16:1 = | RAK C 18:1et | C 18:2 n-6 = | C 18:3 n-3 = |
| | 27.236 + | isomere = 384.28 + | 91.303 + ,01988 * | 19.402 − ,0024 * C |
| | ,05048 * C | ,64439 * C 16:0 | C 16:0 | 16:0 |
| | 16:0 | | | |
| C 16:1 | | RAK C 18:1et | C 18:2 n-6 = | C 18:3 n-3 = |
| | | isomere = 279.96 + | 91.486 + ,16901 * | 16.921 + ,03058 * |
| | | 7.7512 * C 16:1 | C 16:1 | C 16:1 |
| C 18:1et | | | C 18:2 n-6 = | C 18:3 n-3 = |
| isomere | | | 93.580 + ,00931 * | 17.069 + ,00204 * |
| | | | RAK C 18:1et | RAK C 18:1et |
| | | | isomere | isomere |
| C 18:2 n-6 | | | | C 18:3 n-3 = |
| | | | | 14.055 + ,04364 * |
| | | | | C 18:2 n-6 |
| C 18:3 n-3 | | | | |
| C 20:4 n-6 | | | | |
| C 20:5 n-3 | | | | |
| C 22:5 n-3 | | | | |
| C 22:6 n-3 | | | | |

| | C 20:4 n-6 | C 20:5 n-3 | C 22:5 n-3 | C 22:6 n-3 |
|---|---|---|---|---|
| AGS | C 20:4 n-6 = | C 20:5 n-3 = | C 22:5 n-3 = | C 22:6 n-3 = |
| | 13.346 − ,6E−3 * | 2.9761 + ,65E−3 * | 5.4699 + ,13E−3 * | 3.3525 + ,30E−4 * |
| | AGS | AGS | AGS | AGS |
| AGMI | C 20:4 n-6 = | C 20:5 n-3 = | C 22:5 n-3 = | C 22:6 n-3 = |
| | 12.269 + ,72E−3 * | 3.2144 + ,61E−3 * | 5.3084 + ,41E−3 * | 3.2747 + ,18E−3 * |
| | AGMI | AGMI | AGMI | AGMI |
| AGPI | C 20:4 n-6 = | C 20:5 n-3 = | C 22:5 n-3 = | C 22:6 n-3 = |
| | 8.8619 + ,02273 * | 2.3731 + ,00710 * | 3.6084 + ,01161 * | 2.9667 + ,00199 * |
| | AGPI | AGPI | AGPI | AGPI |
| AGPI n-3 | C 20:4 n-6 = | C 20:5 n-3 = | C 22:5 n-3 = | C 22:6 n-3 = |
| | 9.0108 + ,12560 * | 1.9774 + ,05308 * | 3.4934 + ,07018 * | 2.8523 + ,01463 * |
| | AGPI n-3 | AGPI n-3 | AGPI n-3 | AGPI n-3 |
| C 16:0 | C20:4 n-6 = | C 20:5 n-3 = | C 22:5 n-3 = | C22:6 n-3 = |
| | 12.705 + 14E−3 * | 3.4050 + ,50E−3 * | 5.5538 + ,96E−4 * | 3.3924 − ,3E−4 * C |
| | C 16:0 | C 16:0 | C 16:0 | 16:0 |
| C 16:1 | C 20:4 n-6 = | C 20:5 n-3 = | C 22:5 n-3 = | C 22:6 n-3 = |
| | 12.434 + ,00683 * | 3.3464 + ,00537 * | 5.4642 + ,00266 * | 3.2399 + ,00348 * |
| | C 16:1 | C 16:1 | C 16:1 | C 16:1 |
| C 18:1et | C20:4 n-6 = | C20:5 n-3 = | C 22:5 n-3 = | C22:6 n-3 = |
| isomere | 12.464 + ,46E−3 * | 3.0858 + 86E−3 * | 5.4420 + ,23E−3 * | 3.0871 + ,52E−3 * |
| | RAK C 18:1et | RAK C 18:1et | RAK C 18:1et | RAK C 18:1et |
| | isomere | isomere | isomere | isomere |
| C 18:2 n-6 | C 20:4 n-6 = | C 20:5 n-3 = | C 22:5 n-3 = | C 22:6 n-3 = |
| | 7.3830 + ,05399 * | 1.4992 + ,02124 * | 2.9505 + ,02664 * | 1.7114 + ,01220 * |
| | C 18:2 n-6 | C 18:2 n-6 | C 18:2 n-6 | C 18:2 n-6 |
| C 18:3 n-3 | C 20:4 n-6 = | C 20:5 n-3 = | C 22:5 n-3 = | C 22:6 n-3 = |
| | 9.6869 + ,16726 * | 2.5109 + ,05721 * | 4.0704 + ,08274 * | 3.0243 + ,01617 * |
| | C 18:3 n-3 | C 18:3 n-3 | C 18:3 n-3 | C 18:3 n-3 |
| C 20:4 n-6 | | C 20:5 n-3 = | C 22:5 n-3 = | C 22:6 n-3 = |
| | | 1.5882 + ,15248 * | 2.2006 + ,26450 * | 2.9619 + ,02275 * |
| | | C 20:4 n-6 | C 20:4 n-6 | C 20:4 n-6 |
| C 20:5 n-3 | | | C 22:5 n-3 = | C 22:6 n-3 = |
| | | | 2.0630 + 1.0189 * | 2.2670 + ,19607 * |
| | | | C 20:5 n-3 | C 20:5 n-3 |
| C 22:5 n-3 | | | | C 22:6 n-3 = |
| | | | | 2.5655 + ,09662 * |
| | | | | C 22:5 n-3 |
| C 22:6 n-3 | | | | |

TABLE 10
Example of inter-tissue correlation and prediction in pigs. Data obtained for
alpha-linolenic acid (C18:3n-3, ALA) expressed in % of total fatty acids. All the
correlations are significant at the threshold of 0.001%.

| | Bardière | Côte | Foie |
|---|---|---|---|
| Bardière | | n = 49; r² = 0.98 | n = 99; r² = 0.81 |
| | | Bardière = 1.28 × Cote crue + | Bardière = 1.42 × Foie + 0.40 |
| | | 0.04 | |
| Côte | n = 49; r² = 0.98 | | n = 49; r² = 0.80 |
| | Cote crue = 0.77 × Bardière + | | Cote crue = 1.02 × Foie + 0.31 |
| | 0.01 | | |
| Foie | n = 99; r² = 0.81 | n = 49; r² = 0.80 | |
| | Foie = 0.57 × Bardière + | Foie = 0.78 × Cote crue + 0.05 | |
| | 0.10 | | |
| Long Dorsal | n = 129; r² = 0.93 | n = 49; r² = 0.96 | n = 99; r² = 0.82 |
| | LD = 0.42 × Bardière + 0.10 | LD = 0.53 × Cote crue + 0.08 | LD = 0.61 × Foic + 0.23 |
| Semi | n = 52; r² = 0.97 | n = 49; r² = 0.97 | n = 51; r² = 0.85 |
| Membraneux | SM = 0.49 × Bardière + 0.11 | SM = 0.58 × Cote crue + 0.17 | SM = 0.69 × Foie + 0.28 |

| | Long Dorsal | Semi Membraneux | Plasma |
|---|---|---|---|
| Bardière | n = 129; r² = 0.93 | n = 52; r² = 0.97 | n = 120; r² = 0.83 |
| | Bardière = 2.23 × LD − 0.00 | Bardière = 1.98 × SM − | Bardière = 0.97 × plasma + |
| | | 0.14 | 0.54 |
| Côte | n = 49; r² = 0.96 | n = 49; r² = 0.97 | n = 44; r² = 0.82 |
| | Cote crue = 1.83 × LD − 0.07 | Cote crue = 1.68 × SM − | Cote crue = 0.58 × plasma + |
| | | 0.24 | 0.36 |
| Foie | n = 99; r² = 0.82 | n = 51; r² = 0.85 | n = 91; r² = 0.82 |
| | Foie = 1.35 × LD − 0.01 | Foie = 1.23 × SM − 0.11 | Foie = 0.6 × plasma + 0.30 |
| Long Dorsal | | n = 52; r² = 0.97 | n = 121; r² = 0.79 |
| | | LD = 0.87 × SM − 0.03 | LD = 0.49 × plasma + 0.21 |
| Semi | n = 52; r² = 0.97 | | n = 45; r² = 0.84 |
| Membraneux | SM = 1.12 × LD + 0.08 | | SM = 0.36 × plasma + 0.35 |

TABLE 11
Example of inter-tissue correlation and prediction in cattle. Data
obtained for alpha-linolenic acid (C18:3n-3, ALA) expressed in
% of total fatty acids and in mg/100 g. All the correlations are
significant at the threshold of 0.001%.

| | C18:3 % | C18:3 % | C18:3 % |
|---|---|---|---|
| | Long dorsal | Hampe | Bavette |
| C18:3 % | | 0.57 | 0.61 |
| Long dorsal | | | |
| C18:3 % | 0.57 | | 0.79 |
| Hampe | | | |
| C18:3 % | 0.61 | 0.79 | |
| Bavette | | | |
| C18:3 % | | C18:3_%_H = | C183_%_B = |
| Long dorsal | | ,24321 + | ,21825 + |
| | | ,51504 * | ,61971 * |
| | | C183_%_LD | C183_%_LD |
| C18:3 % | | | C183_%_B = |
| Hampe | | | ,12810 + |
| | | | ,87619 * |
| | | | C183_%_H |
| C18:3 % | | | |
| Bavette | | | |

| | C18:3 mg | C18:3 mg | C18:3 mg |
|---|---|---|---|
| | Long dorsal | Hampe | Bavette |
| C18:3 mg | | 0.76 | 0.57 |
| Long dorsal | | | |
| C18:3 mg | 0.76 | | 0.72 |
| Hampe | | | |
| C18:3 mg | 0.57 | 0.72 | |
| Bavette | | | |
| C18:3 mg | | C183_mg_H = | C183_mg_B = |
| Long dorsal | | 4.2378 + | 7.6913 + |
| | | 2.8594 * | ,73464 * |
| | | C183_mg_LD | C183_mg_LD |
| C18:3 mg | | | C183_mg_B = |
| Hampe | | | 7.7733 + |
| | | | ,23975 * |
| | | | C183_mg_H |
| C18:3 mg | | | |
| Bavette | | | |

TABLE 12
Example of inter-tissue correlation and prediction in cattle. Data
obtained for palmitic acid (C16:0) expressed in % of total fatty
acids and in mg/100 g. All the correlations are significant at the
threshold of 0.001%.

| | C16_% | | |
|---|---|---|---|
| | Long | C16_% | C16_% |
| | Dorsal | Hampe | Bavette |
| C16_% | | 0.84 | 0.89 |
| Long | | | |
| Dorsal | | | |
| C16_% | 0.84 | | 0.70 |
| Hampe | | | |
| C16_% | 0.89 | 0.70 | |
| Bavette | | | |
| C16_% | | C16_%_H = | C16_%_B = |
| Long | | 6.9466 + | 4.5996 + |
| Dorsal | | ,59343 * | ,81918 * |
| | | C16_%_LD | C16_%_LD |
| C16_% | | | C16_%_B = |
| Hampe | | | 4.1123 + |
| | | | ,93134 * |
| | | | C16_%_H |
| C16_% | | | |
| Bavette | | | |

| | C16_mg | | |
|---|---|---|---|
| | Long | C16_mg | C16_mg |
| | Dorsal | Hampe | Bavette |
| C16_mg | | 0.67 | 0.73 |
| Long | | | |
| Dorsal | | | |
| C16_mg | 0.67 | | 0.48 |
| Hampe | | | |
| C16_mg | 0.73 | 0.48 | |
| Bavette | | | |
| C16_mg | | C16_g_H = | C16_g_B = |
| Long | | 675.75 + | 214.68 + |
| Dorsal | | 1.5175 * | ,97840 * |
| | | C16_g_LD | C16_g_LD |
| C16_mg | | | C16_g_B = |
| Hampe | | | 303.94 + |
| | | | ,28530 * |
| | | | C16_g_H |
| C16_mg | | | |
| Bavette | | | |

1. Method for determining the amount of at least some of the fatty acids contained in various biological materials of the same animal raised for meat production, from a database in which the fatty acid compositions or profiles have been determined beforehand, for a reference material coming from the same type of animal, determined by gas phase chromatography, then measuring and recording the corresponding infrared absorption spectra or corresponding Raman scattering, which method comprises the following steps:
a/ a calibration equation corresponding to the determination of a fatty acid or a sum of fatty acids by a spectroscopic method is determined for a sample of this reference material by a mathematic model;
b/ the use of said calibration equation of the preceding step is validated, in view of its use with new samples to be analyzed, since for a series of so-called “validation” samples of the same nature as the biological reference material, the correlation coefficient r² between the fatty acid content considered or the sum of fatty acids obtained by gas phase chromatography and spectroscopy, is at least equal to 0.7;
c/ a new sample to be analyzed, of the same nature as the reference material, is subjected to light radiation to obtain the absorption spectrum, and the previously validated calibration equation is used to deduce the profile, i.e., the so called “major” fatty acid content, namely those with a correlation coefficient r² at least equal to 0.7;
wherein this method also comprises at least one of the following steps:
d/ the profile, i.e., the so-called “minor” fatty acid content, namely those whose coefficient r² is less than 0.7, is determined from the profile of “major” fatty acids as determined in the previous step, using statistical prediction equations with a correlation coefficient r² at least greater than correlation coefficient r² determined between the so-called “minor” fatty acids, measured by spectroscopy and the values obtained by gas phase chromatography, or using statistical prediction equations with a correlation coefficient at least equal to 0.7, obtained with the gas phase chromatography method;
e/ the fatty acid content of at least one other material from the same animal is determined, from the profiles obtained in steps c/ and/or d/, by means of statistical prediction equations with a correlation coefficient at least equal to 0.7, obtained with the gas phase chromatography method.

2. Method according to claim 1, wherein in steps b/, c/, d/ and e/, r² is at least equal to 0.8, preferably at least equal to 0.9.

3. Method according to claim 1 wherein said biological material is fluid.

4. Method according to claim 3, wherein said biological material is blood.

5. Method according to claim 1, wherein said biological material is solid.

6. Method according to claim 5, wherein: the biological material is chosen from among fur, scales, feathers, skin, fat, meat or offal.

7. Method according to claim 1 wherein said animal is chosen in the group consisting of cattle, sheep, poultry, pigs, rabbits and fish.
